(19) United States
(12) Patent Application Publication
(10) Pub. No.: US 2015/0203133 A1
(43) Pub. Date: Jul. 23, 2015

(54) Heat Indicator Bracket

(71) Applicant: MSR Rail Products Inc., Mississauga (CA)

(72) Inventor: Robert J. McKeracher, Mississauga (CA)

(21) Appl. No.: 14/592,210

(22) Filed: Jan. 8, 2015

(30) Foreign Application Priority Data
Jan. 18, 2014 (CA) 2,838,933

(51) Int. Cl. B61F 15/20; F16M 13/02

(52) U.S. Cl. CPC B61F 15/20; F16M 13/02

(57) ABSTRACT

A heat indicator bracket for retaining a railcar wheel bearing heat indicator within a receptacle in a bearing housing to which the wheel is mounted. The bracket has a ring having a passage therethrough which is insertable into the receptacle to prevent the heat indicator from exiting the receptacle while allowing visual confirmation that through the passage of the presence of the heat indicator and that it has not discharged. An arm extends from the ring and has a passage therethrough for receiving a fastener to secure the bracket to the housing.

This application takes priority from Canadian patent application having the Canadian Serial Number 2,838,933 filed on Jan. 8, 2014, which is incorporated herein by reference.

### FIELD

The claimed device relates generally to railway cars. More particularly, this invention relates to wheel bearings associated with railway car wheel sets. Still more particularly, this invention relates to heat indicators for railway car wheel bearings.

### BACKGROUND

A typical railway car is supported for rolling along a railway track by a plurality of wheel sets. FIG. 1 discloses a perspective view of a typical railway car wheel set 10 that would be used on a commuter train. The wheel set 10 comprises a pair of wheels 12 joined by an axle 14. At opposite ends of the axle 14 is a respective bearing housing 20 extending about the axle. The bearing housing contains at least two races of roller bearings for rotationally supporting the axle. The bearing housing acts as an interface to mount the wheel sets to a railway car. The roller bearings are not visible in the illustrations however persons skilled in the art would be familiar with the arrangement.

Although bearings used with railway cars are typically quite robust, they do eventually wear out. If a worn out bearing completely fails, it will pose a safety hazard and may, for example, cause train derailment.

Bearing failure is usually preceded by overheating of the bearing. Accordingly, as a safety precaution, a heat indicator is mounted to the bearing housing. As such, FIG. 2 is a perspective view of a typical heat indicator generally indicated by reference 30. The heat indicator basically comprises a cylinder 32 having an outlet end 34. The cylinder is filled with an odiferous (smelly) compound—hence the nickname “stink bomb” for the heat indicator 30.

In the presence of heat, the odiferous compound is released through the outlet end 34 of the heat indicator 30 causing a smell indicative of imminent bearing failure.

FIG. 2a shows a perspective view of a close-up of the end 34. The end 34 is slightly smaller in diameter than the cylinder 32 and has a circular discharge passage 36 at its center.

The passage 36 is shown as sealed. Were the contents of the heat indicator 30 discharge, the passage 36 would be open to provide a visual indication of discharge.

FIG. 3 is a perspective view corresponding to the upper left hand side of FIG. 1 albeit on a larger scale. FIG. 3 illustrates a hole 22 in the upper right portion of bearing housing 20 into which the heat indicator 30 is inserted. According to past practice, the heat indicator 30 would be maintained within the hole by a circlip 40 such as the two shown on top of the bearing housing 20 disclosed in FIG. 3 and shown in perspective on its own in FIG. 4. A problem with such a retaining arrangement is that the circlips 40 have been known to fall out, which ultimately results in the heat indicator 30 also falling out as a result of railcar movement. Accordingly, a more robust retention system is required that provides visual access to at least a portion of the heat indicator so that its presence may be confirmed.

### SUMMARY

A heat indicator bracket is provided for retaining a railcar wheel bearing heat indicator within a receptacle in a bearing housing to which the wheel is mounted. The bracket has a ring having a passage therethrough which is insertable into the receptacle to prevent the heat indicator from exiting the receptacle while allowing visual confirmation that through the passage of the presence of the heat indicator and that it has not discharged. An arm extends from the ring and has a passage therethrough for receiving a fastener to secure the bracket to the housing. Preferably, the arm is shaped and dimensioned to register with an existing fastener hole in the housing. The existing fastener hole may be used for securing a speed sensor mounting bracket.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a perspective view of a prior art railway car wheel set;

FIG. 2 is a perspective view of a prior art heat indicator;

FIG. 2a is a perspective view of an outlet end of the heat indicator of FIG. 2;

FIG. 3 is a perspective larger scale view that corresponds to the upper left hand side of FIG. 1;

FIG. 4 is a perspective view of a prior art circlip;

FIG. 5 is a perspective view from below and to one side of a bracket according to the present invention;

FIG. 6 is a perspective view from below and toward one side of the brackets;

FIG. 7 is a perspective view from above and toward one side of the brackets;

FIG. 8 is a perspective view showing the underside and part of one side of the bracket;

FIG. 9 shows the opposite side of the bracket of FIG. 8;

FIG. 10 is a perspective view illustrating the bracket being mounted to a bearing housing;

FIG. 11 shows the bracket of FIG. 10 after being mounted to the bearing housing of FIG. 10;

FIG. 12 is a perspective view showing the heat indicator visible through the bracket;

FIGS. 13A, 13B and 13C are, respectively front, bottom and end views of an exempla bracket, showing the dimensions of the bracket; and,

FIGS. 14A, 14B and 14C correspond respectively to FIGS. 13A, 13B and 13C, showing different dimensions of the bracket.

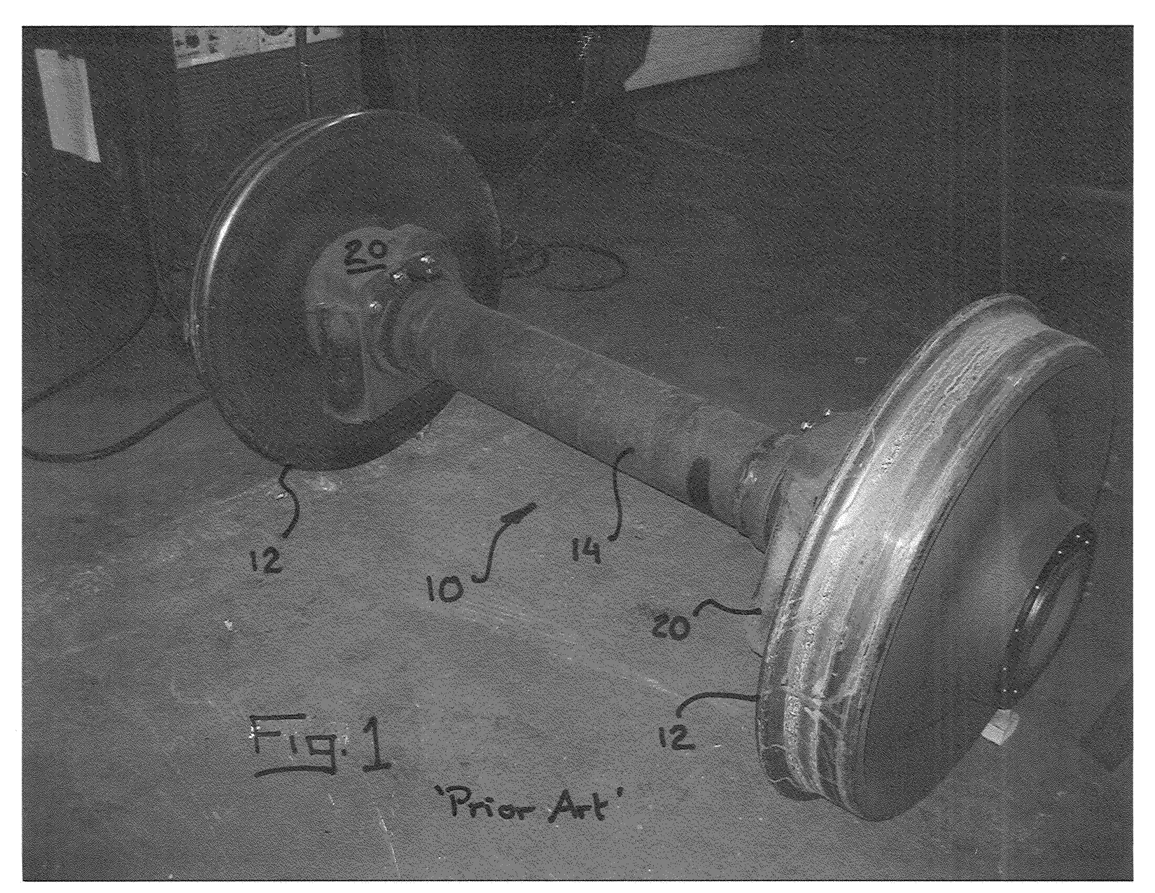

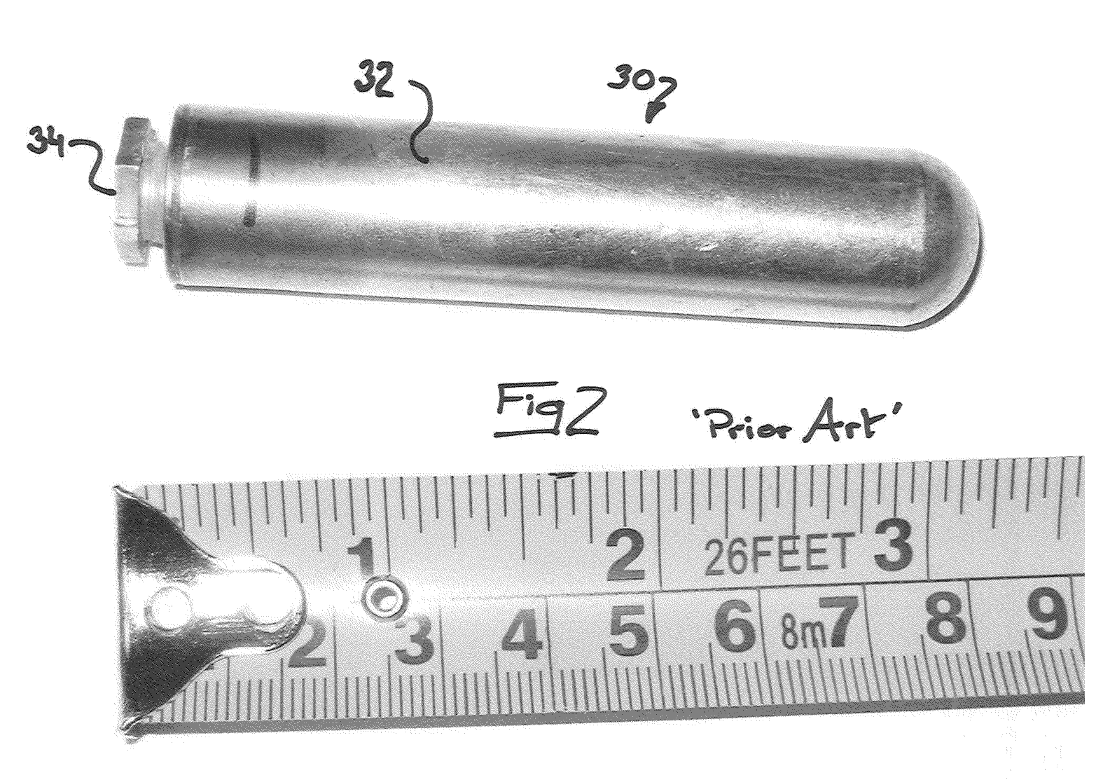

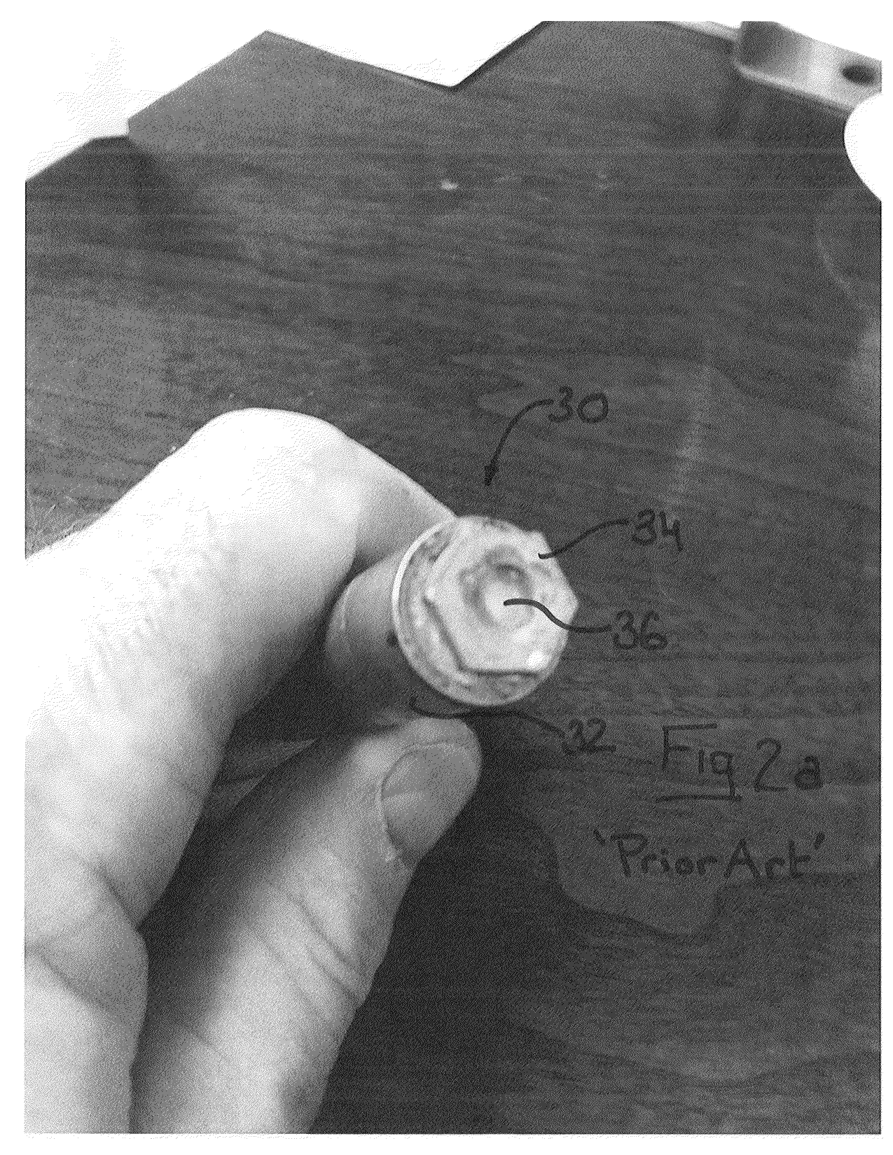

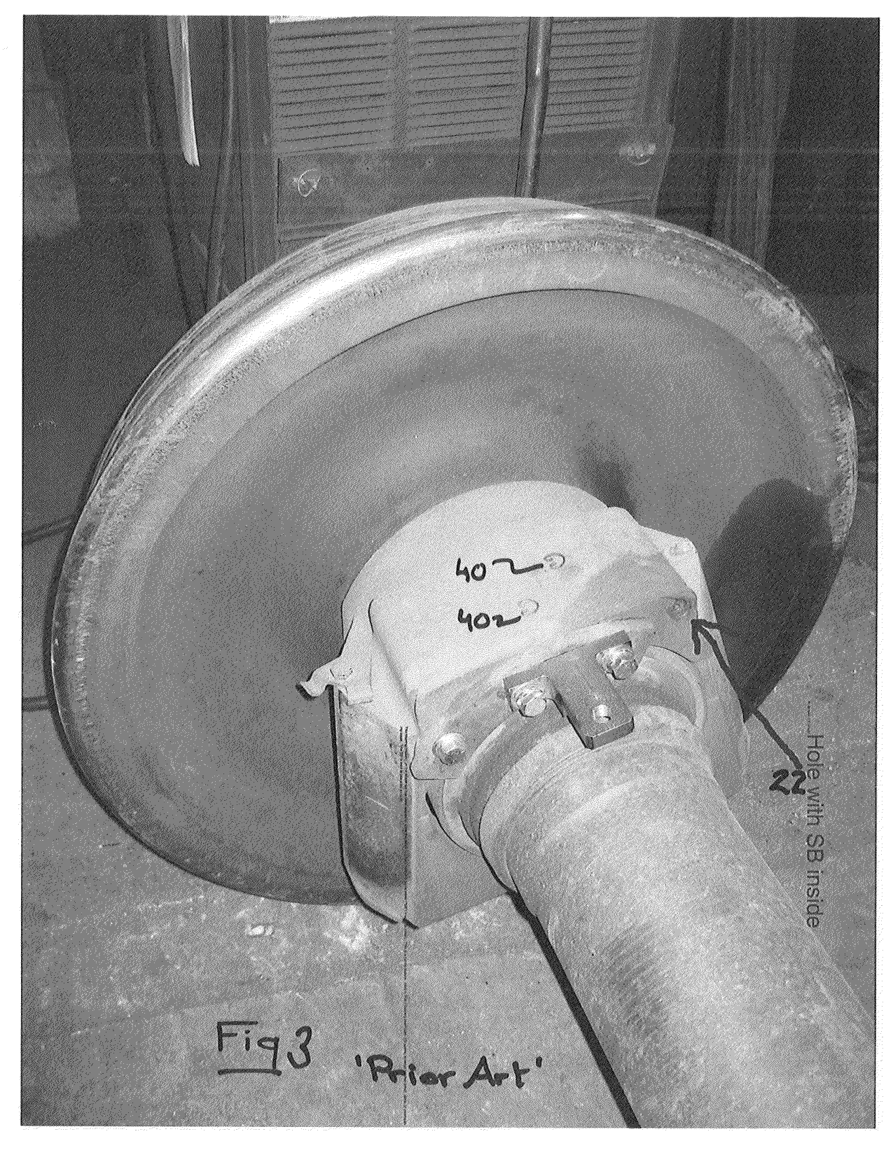

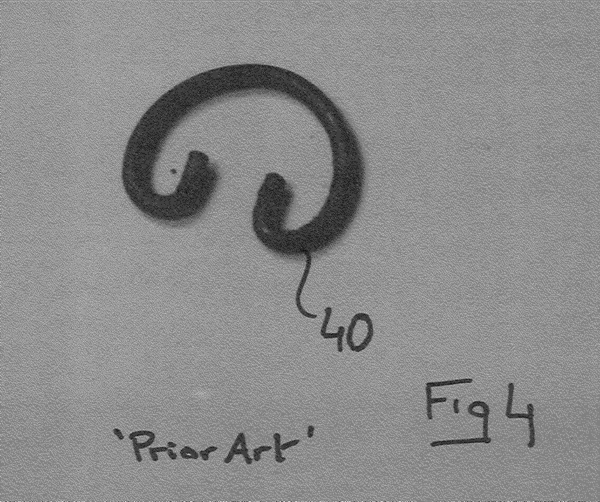

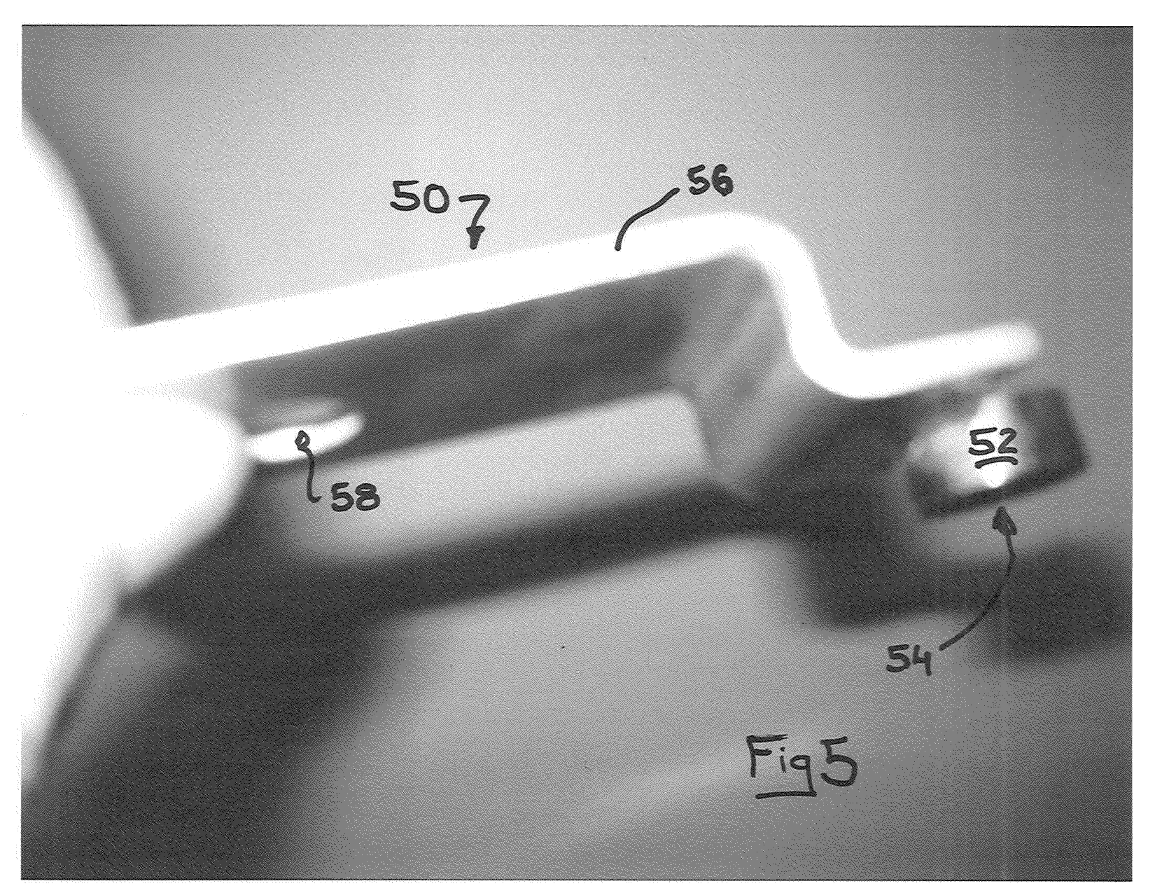

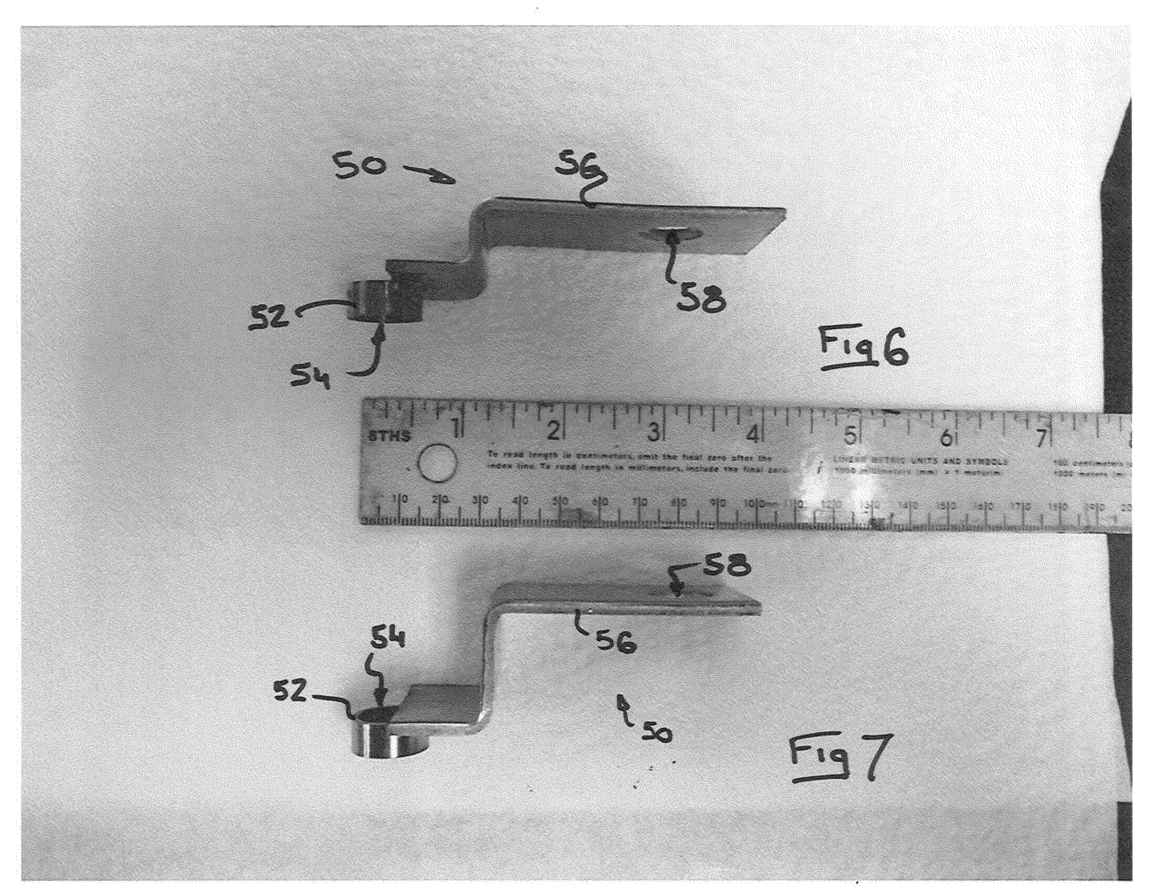

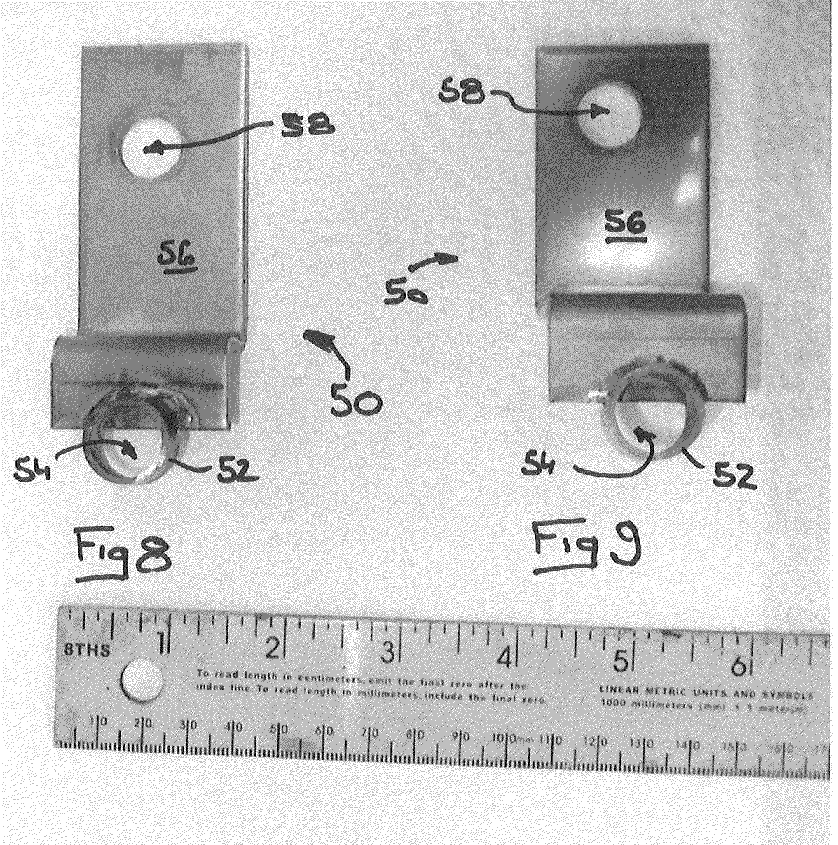

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

The heat indicator bracket is generally identified by reference 50 in the accompanying illustrations. The heat indicator bracket (or simply “bracket 50”) retains the heat indicator 30 within the receptacle 22 in the bearing housing 20. The bracket 50 has a ring 52 having a passage 54 therethrough. The ring 52 is insertable into the receptacle 22. The ring is of smaller diameter than the heat indicator 30 thereby preventing the heat indicator 30 from exiting the receptacle while the bracket 50 is in place. The passage 54 permits visual confirmation of the presence of the heat indicator 30 in the receptacle 22 and that it has not discharged. An arm 56 extends from the ring 52. The arm 56 has a hole 58 through it for receiving a threaded fastener 60, as shown in FIG. 10 and FIG. 11. The threaded fastener is inserted through the arm and then into a threaded opening 62 in the bearing housing 20 for securing the arm and in turn, the bracket to the bearing housing 20.

Preferably, the arm is shaped and dimensioned for the hole to register with an existing fastener hole in the bearing housing 20. This will avoid having to further drill and tap into the bearing housing 20. For example, the arm 56 may be shaped and dimensioned for the hole 58 to register with the hole 62 which receives a fastener for a speed indicator mounting bracket 70. Different applications may require different shaping and dimensioning of the arm 56. For example, the arm 56 of the bracket 50 in FIG. 7 has more offset than the arm 56 of the bracket 50 in FIG. 6.

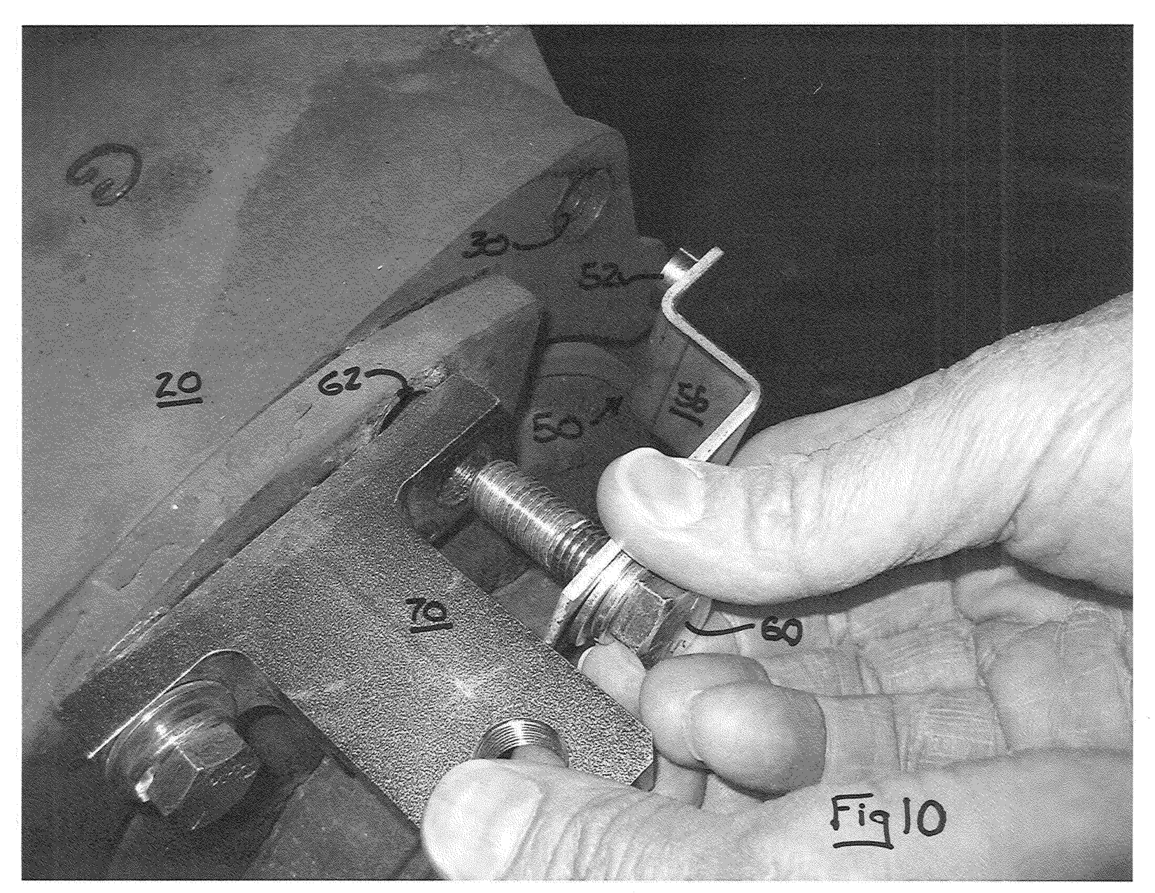

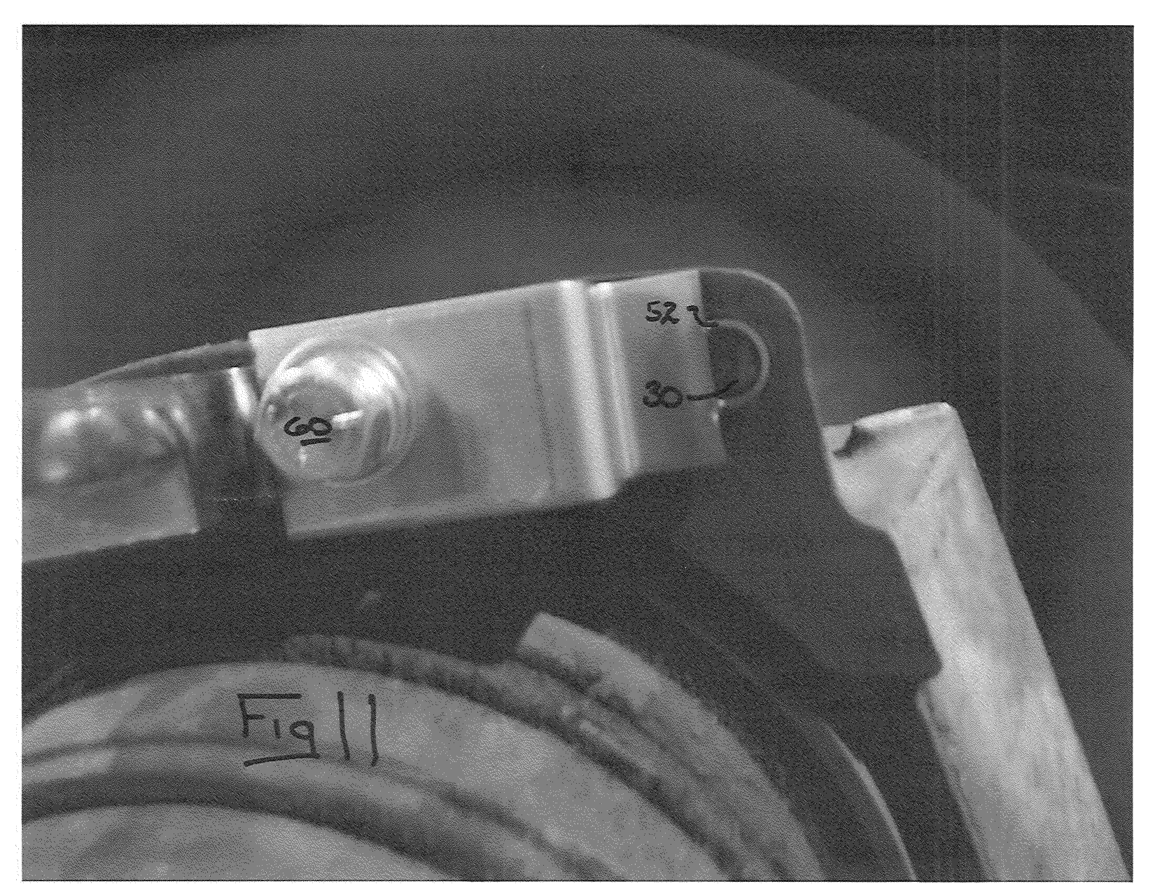

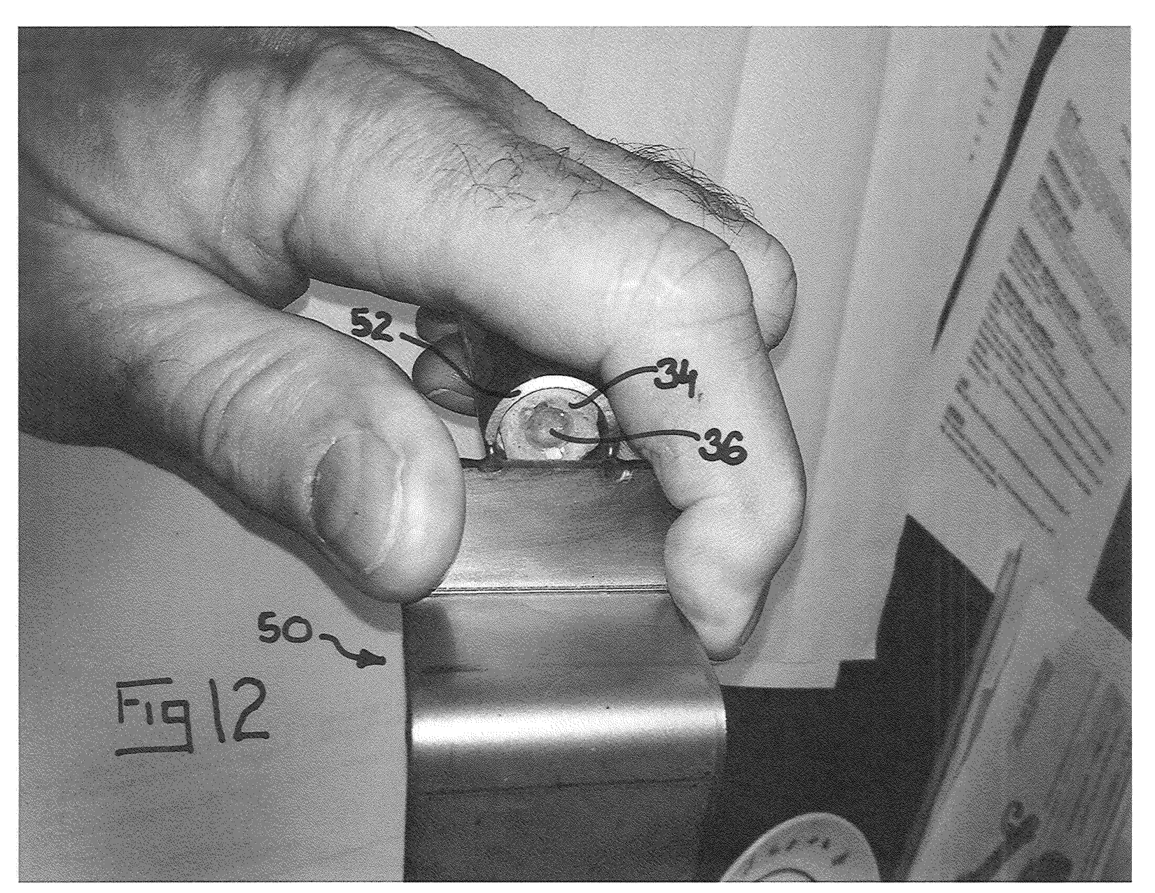

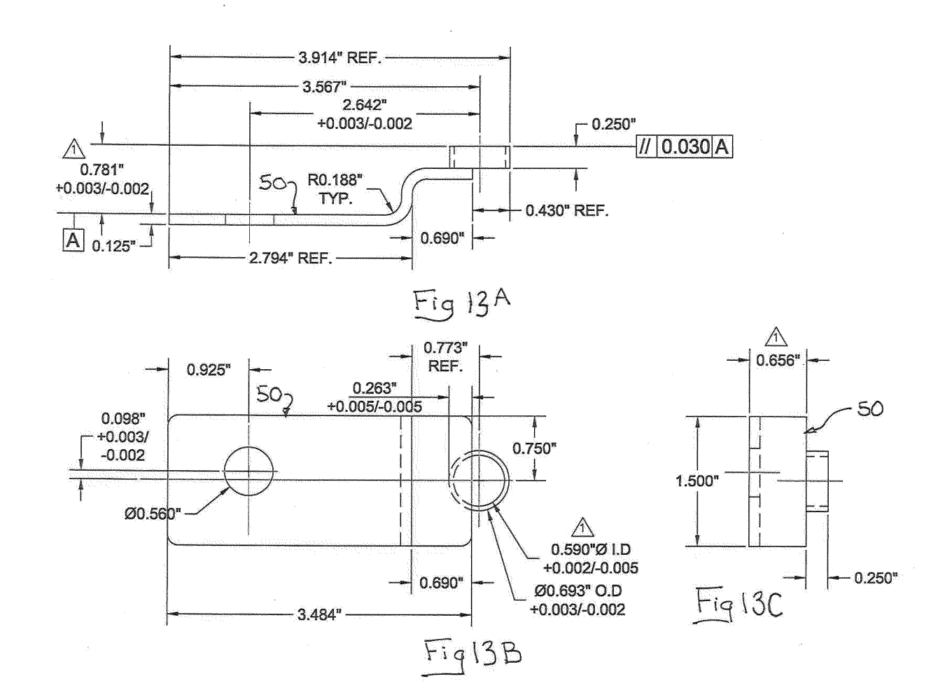

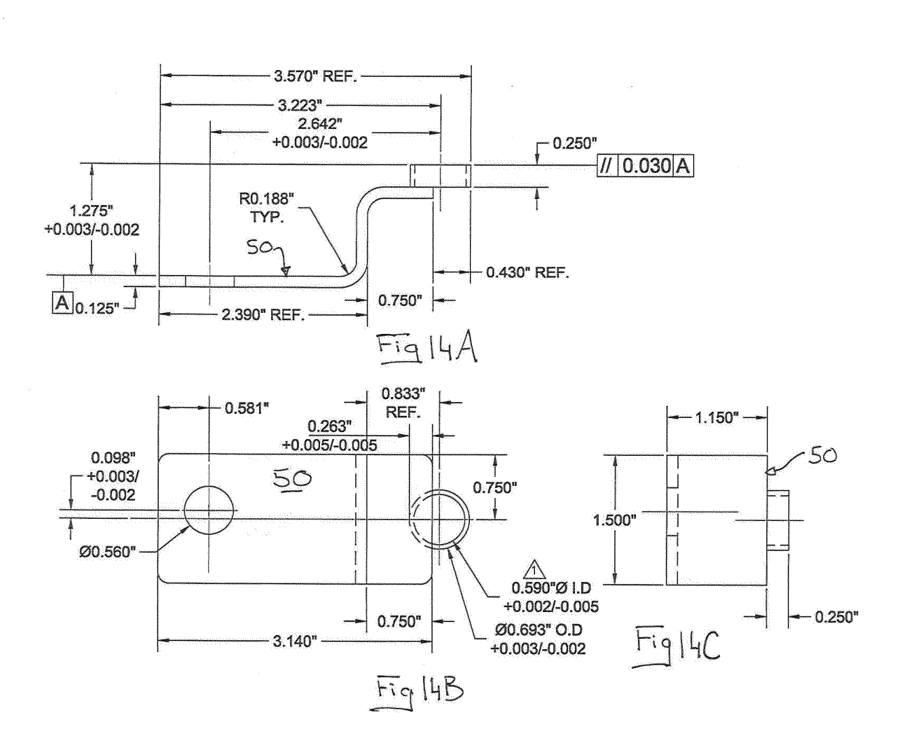

FIG. 10 illustrates the process of installing the bracket 50 utilizing a threaded hole 62 associated with the speed indicator mounting bracket 70. FIG. 11 illustrates the installed bracket 50 and how the heat indicator 30 is visible through the passage 54 through the ring 52. FIG. 12 shows more clearly how the end 34 and discharge passage 36 of the heat indicator are visible through the ring 52 of the bracket 50.

This invention has been described with reference to several embodiments. Many modifications and alterations will occur to others upon reading and understanding the preceding specification. It is intended that the invention be construed as including all such alterations and modifications in so far as they come within the scope of the appended claims or the equivalents of these claims.

### PARTS

10 wheel set

12 wheel

14 axle

20 bearing housing

22 receptacle

30 heat Indicator

32 cylinder

34 outlet end

36 discharge passage

40 circlip

50 bracket

52 ring

54 passage

56 arm

58 hole

60 fastener

62 threaded opening

70 speed indicator mounting bracket

What is claimed is:

1. A heat indicator bracket for retaining a railcar wheel bearing heat indicator within a receptacle in a bearing housing to which a railcar wheel is mounted, said bracket comprising:
a ring having a passage therethrough, said ring is insertable into said receptacle an as to prevent said heat indicator from exiting said receptacle while said passage allows visual confirmation of the presence of said heat indicator and that it has not discharged; and,
an arm extending from said ring, said arm having a hole therethrough for receiving a fastener to secure said bracket to said bearing housing.

2. The heat indicator bracket of claim 1 wherein said arm is shaped and dimensioned for the hole register with an existing fastener hole in said housing.

3. The heat indicator bracket of claim 1 wherein said arm is shaped and dimensioned for the hole register with an existing fastener hole in said housing and the existing fastener hole is for securing a speed sensor mounting bracket.
